(19) United States
(12) Patent Application Publication
(10) Pub. No.: US 2019/0301704 A1
(43) Pub. Date: Oct. 3, 2019

(54) LIGHT SOURCE WINDOW MEMBER

(71) Applicant: Murata Manufacturing Co., Ltd., Nagaokakyo-shi (JP)

(72) Inventors: Yuichiro Nagamine, Nagaokakyo-shi (JP); Kazuyuki Noto, Nagaokakyo-shi (JP)

(21) Appl. No.: 16/445,456

(22) Filed: Jun. 19, 2019

Related U.S. Application Data
(63) Continuation of application No. PCT/JP2017/030164, filed on Aug. 23, 2017.

(30) Foreign Application Priority Data
Jan. 23, 2017 (JP) 2017-009598

(51) Int. Cl. F21V 3/06; F21V 7/00

(52) U.S. Cl. CPC F21V 3/06; F21V 7/0016

(57) ABSTRACT

A light source window member for applying irradiation light from a light source that includes a tubular side wall member extending in a longitudinal direction and constructed to contain the light source therein; and an irradiation window region provided at at least one surface of the tubular side wall member, and the irradiation window region is made of artificial quartz.

### CROSS REFERENCE TO RELATED APPLICATIONS

The present application is a continuation of International application No. PCT/JP2017/030164, filed Aug. 23, 2017, which claims priority to Japanese Patent Application No. 2017-009598, filed Jan. 23, 2017, the entire contents of each of which are incorporated herein by reference.

### FIELD OF THE INVENTION

The present invention relates to a light source window member.

### BACKGROUND OF THE INVENTION

It is known that, in a process of washing the surface of an object to be treated, such as a semiconductor wafer and a substrate, etc., irradiated light (for example, ultraviolet light) having a predetermined wave length is applied to the object to be treated. For example, Patent Document 1 discloses use of a transparent circular plate-shaped cover member made of artificial quartz or colorless transparent natural quartz for a cylindrical container that seals an excimer discharge lamp.

Patent Document 1: Japanese Unexamined Patent Application Publication No. 2014-186887

### SUMMARY OF THE INVENTION

However, although improvement of light transmission efficiency for irradiated light is required for a light source window member through which irradiated light from a light source is applied, the region of the window member in Patent Document 1 is small, and thus sufficient light transmission efficiency cannot be obtained in some cases.

The present invention has been made in view of such circumstances, and an object of the present invention is to provide a light source window member that is able to improve light transmission efficiency.

A light source window member for applying irradiation light from a light source according to one aspect of the present invention includes a tubular side wall member extending in a longitudinal direction and constructed to contain the light source therein, and an irradiation window region provided at at least one surface of the tubular side wall member, wherein the irradiation window region is made of artificial quartz.

According to the above aspect, since the irradiation window region is made of artificial quartz and is provided at at least one surface in the longitudinal direction of the tubular side wall member, it is possible to apply light in a wide range with good transmission properties. Therefore, it is possible to provide a light source window member that is able to improve light transmittance.

### BRIEF DESCRIPTION OF THE DRAWINGS

FIG. 1 is a perspective view of a light source window member according to a first embodiment.

FIG. 2 is a cross-sectional view of the light source window member according to the first embodiment.

FIG. 3 is a diagram for explaining a modification of a plate-shaped member of the light source window member according to the first embodiment.

FIG. 4 a diagram for explaining a modification of the plate-shaped member of the light source window member according to the first embodiment.

FIG. 5 is a cross-sectional view of a light source window member according to a second embodiment.

FIG. 6 is a cross-sectional view of a light source window member according to a third embodiment.

FIG. 7 is a cross-sectional view of a light source window member according to a fourth embodiment.

FIG. 8 is a diagram showing a plate-shaped member of a light source window member according to a fifth embodiment.

FIG. 9 is a diagram showing a plate-shaped member of a light source window member according to a sixth embodiment.

FIG. 10 is a diagram showing a plate-shaped member of a light source window member according to a seventh embodiment.

### DETAILED DESCRIPTION OF THE PREFERRED EMBODIMENTS

Hereinafter, embodiments of the present invention will be described. In the following description of the drawings, identical or similar components are designated by identical or similar signs. The drawings are illustrative, the dimension and the shape of each portion are schematic, and the technical scope of the invention of the present application should not be construed to be limited to the embodiments.

### First Embodiment

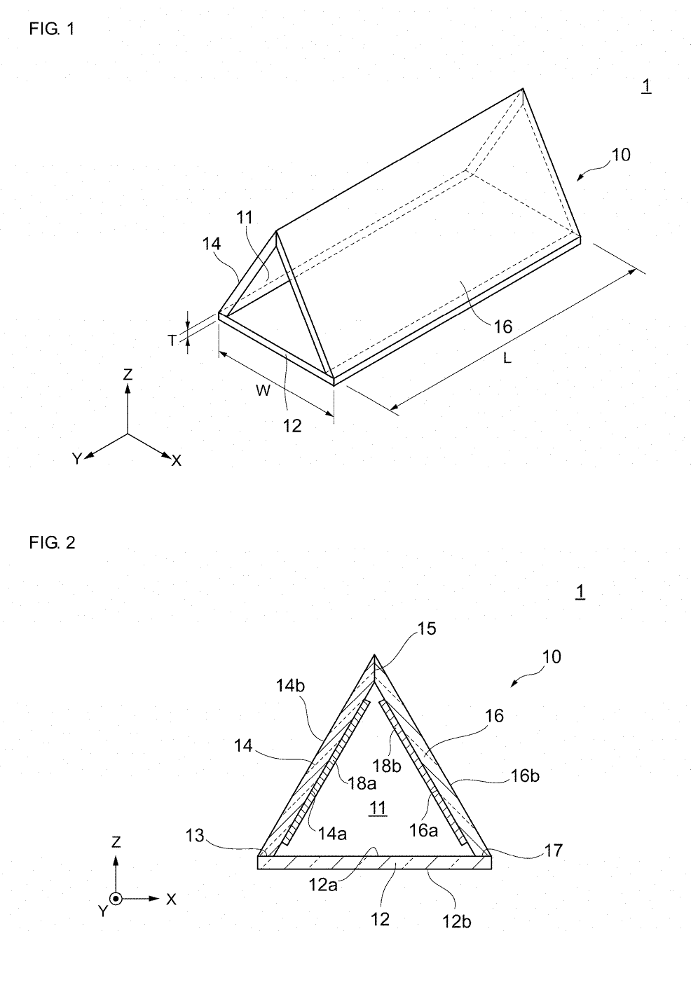

A light source window member according to a first embodiment of the present invention will be described with reference to FIGS. 1 and 2. FIG. 1 is a perspective view of the light source window member. FIG. 2 is a cross-sectional view of FIG. 1 in a direction orthogonal to a longitudinal direction (Y-axis direction). It should be noted that an X-axis, a Y-axis, and a Z-axis in FIGS. 1 and 2 are orthogonal to each other. The relationship between the X-axis, the Y-axis, and the Z-axis is also the same in the other drawings.

As shown in FIG. 1, the light source window member 1 is used for applying irradiation light from a light source (not shown). The light source window member 1 has a tubular side wall member 10 that extends in the longitudinal direction (Y-axis direction); and an irradiation window region that is provided at at least one surface of the tubular side wall member 10 (a plate-shaped member 12 in FIG. 1) and through which the irradiation light from the light source is applied.

In the present embodiment, the light source is not particularly limited, but, for example, a lamp (for example, a mercury lamp), a LED, or the like may be used. As the irradiation light from the light source, there are various types of light in accordance with the use, and examples thereof include ultraviolet light (for example, having a wave length of 400 nm or less) and deep ultraviolet light (for example, having a wave length not less than 150 nm and not greater than 200 nm). The light source window member according to the present embodiment is applicable to, for example, irradiation light having a wave length not less than 140 nm and not greater than 400 nm. Examples of the use of the irradiation light for which the light source window member 1 is used include curing (photo-curing) such as resist-curing and adhesion of an electronic component, exposure for forming circuit patterns of a semiconductor and the like, surface modification to change the physical properties of the surface of a workpiece, and optical washing for removing organics adhering to the surface of a workpiece.

The tubular side wall member 10 has a shape that allows the light source to be contained in an internal space 11 thereof. Accordingly, it is possible to contain a light source, having a shape extending in the longitudinal direction, in the internal space 11, and apply irradiation light to the surface of a workpiece in an integral region extending in the longitudinal direction.

The tubular side wall member 10 has plate-shaped members 12, 14, and 16. In the shown example, the shapes of the plate-shaped member 12, 14, and 16 are the same. Specifically, the plate-shaped members 12, 14, and 16 have the same length L in the longitudinal direction (Y-axis direction), the same width W in a lateral direction (X-axis direction), and the same thickness T in a thickness direction (Z-axis direction). In the present embodiment, the plate-shaped members 12, 14, and 16 are joined to each other in the lateral direction, whereby the tubular side wall member 10 having a polygonal column shape (specifically, a triangular column shape) is formed. As means for joining each of joint portions 13, 15, and 17 of the plate-shaped members 12, 14, and 16, for example, metal joining with a brazing material or the like, glass adhesion, resin adhesion, siloxane bond, or the like may be used.

The plate-shaped members 12, 14, and 16 are each made of artificial quartz. Artificial quartz has a high transmittance in a wide wave length range as compared to other materials (for example, artificial quartz glass) and thus suitably functions as an irradiation window region that transmits the irradiated light from the light source. In the example shown in FIG. 2, the plate-shaped members 12, 14, and 16 have inner surfaces 12a, 14a, and 16a at the light source side, and outer surfaces 12b, 14b, and 16b at the side opposite to the light source. Reflective members 18a and 18b are provided on the respective inner surfaces 14a and 16a of the plate-shaped members 14 and 16. The reflective members 18a and 18b are configured to reflect the irradiation light from the light source. Accordingly, the irradiation light from the light source and the irradiation light reflected by the reflective members 18a and 18b are transmitted through the plate-shaped member 12, and thus it is possible to more effectively apply light.

The reflective members 18a and 18b are each, for example, a reflective film containing silica particles that function as ultraviolet scattering particles. It is possible to easily provide such a reflective film on each of the inner surfaces 14a and 16a of the plate-shaped members 14 and 16, for example, by a chemical vapor deposition method. The reflective film may contain another metal such as alumina particles. It is possible to adjust the reflection intensity of the reflective film as appropriate on the basis of the particle shapes or the sizes of the silica particles, the content ratio of the other metals, etc.

In the present embodiment, the entirety of the plate-shaped member 12 is the irradiation window region. In other words, the irradiation window region extends to both ends in the longitudinal direction of the plate-shaped member 12, and extends to both ends in the lateral direction of the plate-shaped member 12. That is, the irradiation window region has the length L in the longitudinal direction and the width W in the lateral direction.

The crystal axes of the artificial quartz of the plate-shaped member 12 correspond to the X-axis, the Y-axis, and the Z-axis in FIGS. 1 and 2. That is, the plate-shaped member 12 has a main surface parallel to the X-axis and the Y-axis corresponding to the crystal axes of the artificial quartz, and the irradiation light is applied along the Z-axis corresponding to the crystal axis of the artificial quartz. It should be noted that, of the X-axis and the Y-axis corresponding to the crystal axes of the artificial quartz, the X-axis may be the longitudinal direction, or the Y-axis may be the longitudinal direction.

The plate-shaped members 12, 14, and 16 are each a flat plate. That is, the inner surfaces 12a, 14a, and 16a and the outer surfaces 12b, 14b, and 16b of the plate-shaped members 12, 14, and 16 are each a substantially flat surface.

In the present embodiment, the plate-shaped members 12, 14, and 16 are each made of artificial quartz, and thus it is possible to join the plate-shaped members 12, 14, and 16 to each other by means of siloxane bond. That is, it is possible to directly join the plate-shaped members 12, 14, and 16 to each other. Specifically, joining surfaces of the plate-shaped members are mirror polished to be made hydrophilic, and OH groups are bound to Si of the quartz plates. Then, the joining surfaces of the quartz plates are brought into contact with and temporarily joined to each other to be bound to the OH groups, the quartz plates are heated to a temperature (for example, 300° C.) less than the transition point of quartz to remove H₂O and form Si—O—Si (siloxane) bond. With such joining means, joining between atoms is possible, and it is possible to firmly join the plate-shaped members 12, 14, and 16 to each other.

As described above, according to the present embodiment, the irradiation window region is made of artificial quartz, and is provided at at least one surface in the longitudinal direction of the tubular side wall member 10, and thus it is possible to apply light in a wide range with good transmission. Therefore, it is possible to provide a light source window member that is able to improve light transmittance.

It is possible to form an irradiation device including the light source window member and the light source according to the present embodiment. The irradiation device according to the present embodiment may be an ultraviolet light device in which the light source applies ultraviolet light (for example, a deep ultraviolet light device).

(Modifications)

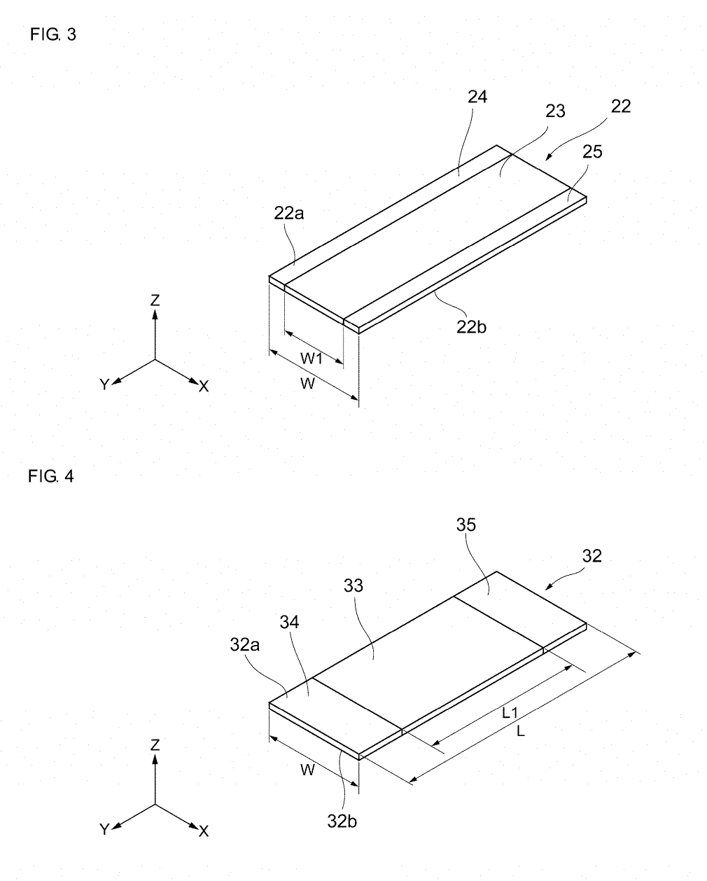

FIGS. 3 and 4 are each a diagram showing a modification of the present embodiment. In each of FIGS. 3 and 4, the configuration of a plate-shaped member having an irradiation window region is different from that in FIGS. 1 and 2. Each modification described below may be used instead of the plate-shaped member 12 in FIGS. 1 and 2.

In the modification shown in FIG. 3, an irradiation window region 23 extends to both ends in the longitudinal direction of a plate-shaped member 22 and is spaced apart from each end portion in the lateral direction of the plate-shaped member 22. That is, when the width in the lateral direction of the irradiation window region 23 is denoted by W1 and the width in the lateral direction of the plate-shaped member 22 is denoted by W, a relationship of W1<W is established. Regions 24 and 25 are provided at one side and the other side in the lateral direction of the irradiation window region 23, respectively. In other words, the irradiation window region 23 is provided between the region 24 and the region 25.

In this modification, at least the irradiation window region 23 is made of artificial quartz. In this modification as well, it is possible to provide the irradiation window region 23 such that the irradiation window region 23 extends in the longitudinal direction of a tubular side wall member, and thus it is possible to improve light transmittance.

It should be noted that, in FIG. 3, the irradiation window region 23 is spaced apart from both end portions, at one side and the other side in the lateral direction, of the plate-shaped member 22, but may be spaced apart from only either one of the end portions in the lateral direction of the plate-shaped member 22.

In the modification shown in FIG. 4, an irradiation window region 33 extends to both ends in the lateral direction of a plate-shaped member 32 and is spaced apart from each end portion in the longitudinal direction of the plate-shaped member 32. That is, when a length in the longitudinal direction of the irradiation window region 33 is denoted by L1 and the length in the longitudinal direction of the plate-shaped member 32 is denoted by L, a relationship of L1<L is established. In this case, for example, a relationship of L1<0.5×L is preferably established. In addition, when the width in the lateral direction of the plate-shaped member 32 is denoted by W, a relationship of L1>W is preferably established. Regions 34 and 35 are provided at one side and the other side in the longitudinal direction of the irradiation window region 33, respectively. In other words, the irradiation window region 33 is provided between the regions 34 and 35.

In this modification, at least the irradiation window region 33 is made of artificial quartz. In this modification as well, it is possible to provide the irradiation window region 33 such that the irradiation window region 33 extends in the longitudinal direction of a tubular side wall member, and thus it is possible to improve light transmittance.

It should be noted that, in FIG. 4, the irradiation window region 33 is spaced apart from both end portions, at one side and the other side in the longitudinal direction, of the plate-shaped member 32, but may be spaced apart from only either one of the end portions in the longitudinal direction of the plate-shaped member 32.

In the above embodiment, the example in which the reflective members 18a and 18b are provided on the plate-shaped members 14 and 16 has been described. However, as a modification, no reflective member may be provided. In this case, it is possible to form each surface of the tubular side wall member 10 as an irradiation window region by forming the plate-shaped members 12, 14, and 16 from artificial quartz.

Moreover, in the above embodiment, the example in which the plate-shaped members 12, 14, and 16 are made of artificial quartz has been described. However, at least one of the plate-shaped members 14 and 16 excluding the plate-shaped member 12 having the irradiation window region may be made of a material different from artificial quartz, such as quartz glass or metal. In this case, a material that does not substantially transmit the light from the light source or reflects the light from the light source may be used for the plate-shaped members 14 and 16.

### Second Embodiment

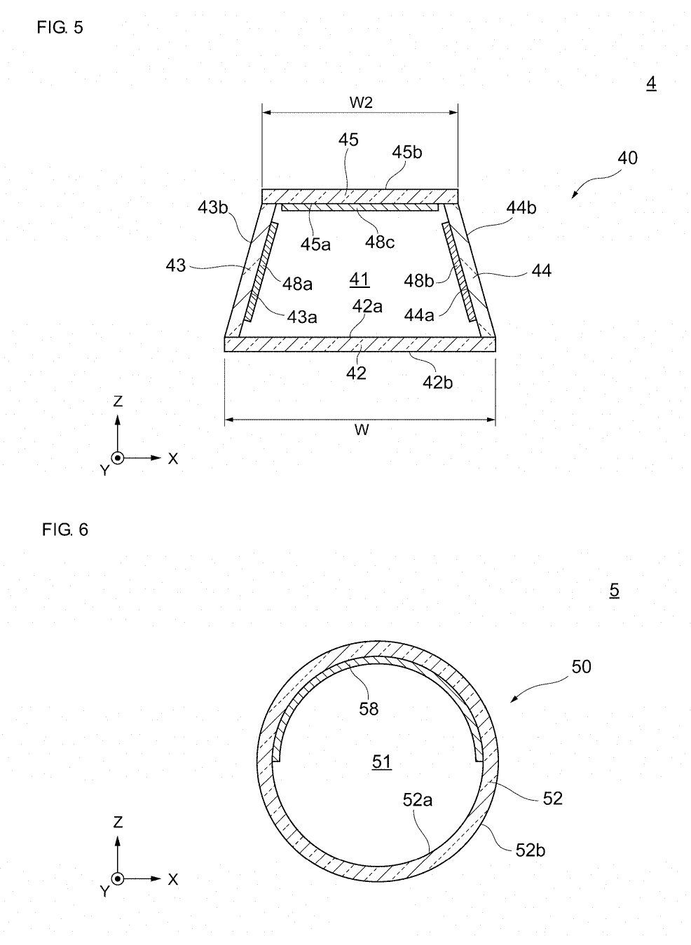

A light source window member according to a second embodiment of the present invention will be described with reference to FIG. 5. FIG. 5 is a cross-sectional view of the light source window member. In the following, the differences from the first embodiment will be described (the same applies to other embodiments that are a third embodiment and subsequent embodiments).

As shown in FIG. 5, the light source window member 4 of the present embodiment is different from the first embodiment in the shape of a tubular side wall member. The light source window member 4 has a tubular side wall member 40 and an irradiation window region that is provided at at least one surface of the tubular side wall member 40 (a plate-shaped member 42 in FIG. 5) and through which irradiated light from a light source is applied. The tubular side wall member 40 allows a light source, having a shape extending in a longitudinal direction to be contained in an internal space 41 thereof.

The tubular side wall member 40 has four plate-shaped members 42, 43, 44, and 45. The plate-shaped members 42, 43, 44, and 45 each have a longitudinal direction (Y-axis direction), and are joined to each other in a lateral direction (X-axis direction), whereby the tubular side wall member 40 having a quadrangular column shape is formed. A width W in the lateral direction of the plate-shaped member 42 having the irradiation window region and a width W2 in the lateral direction of the plate-shaped member 45 facing the plate-shaped member 42 has a relationship of W>W2. As described above, in the example shown in FIG. 5, a cross-section of the tubular side wall member 40 in a direction perpendicular to the longitudinal direction has a trapezoidal shape, and the plate-shaped member 42 having a main surface of the trapezoidal shape that has a larger area has the irradiation window region.

In the example shown in FIG. 5, the plate-shaped members 42, 43, 44, and 45 are each made of artificial quartz. Alternatively, as described above, as a modification, at least one of the plate-shaped members 43, 44, and 45 excluding the plate-shaped member 42 having the irradiation window region may be made of a material different from artificial quartz, such as quartz glass or metal.

In the example shown in FIG. 5, the plate-shaped members 42, 43, 44, and 45 have inner surfaces 42a, 43a, 44a, and 45a at the light source side, and outer surfaces 42b, 43b, 44b, and 45b at the side opposite to the light source, and reflective members 48a, 48b, and 48c are provided on the respective inner surfaces 43a, 44a, and 45a of the plate-shaped members 43, 44, 45. Accordingly, it is possible to also transmit the irradiation light reflected by the reflective members 48a, 48b, and 48c, through the plate-shaped member 42.

It should be noted that the number of plate-shaped members may be five or more, and the tubular side wall member may have a polygonal column shape corresponding to the number of plate-shaped members.

### Third Embodiment

A light source window member according to a third embodiment of the present invention will be described with reference to FIG. 6. FIG. 6 is a cross-sectional view of the light source window member.

As shown in FIG. 6, the light source window member 5 of the present embodiment is different from the first embodiment in the shape of a tubular side wall member. The light source window member 5 has a tubular side wall member 50 and an irradiation window region that is provided at at least one surface of the tubular side wall member 50 (a plate-shaped member 52 in FIG. 6) and through which irradiated light from a light source is applied. The tubular side wall member 50 allows a light source having a shape extending in a longitudinal direction to be contained in an internal space 51 thereof.

The tubular side wall member 50 is composed of a cylindrical plate-shaped member 52. In addition, the plate-shaped member 52 is made of artificial quartz.

In the example shown in FIG. 6, the plate-shaped member 52 has an inner surface 52a at the light source side, and an outer surface 52b at the side opposite to the light source. The inner surface 52a and the outer surface 52b are each a curved surface. A reflective member 58 is provided on a part of the inner surface 52a around an axis in the longitudinal direction (a semicircular portion at the Z-axis positive direction side in FIG. 6). Accordingly, it is possible to also transmit the irradiation light reflected by the reflective member 58, through the other part of the plate-shaped member 52 around the axis in the longitudinal direction.

### Fourth Embodiment

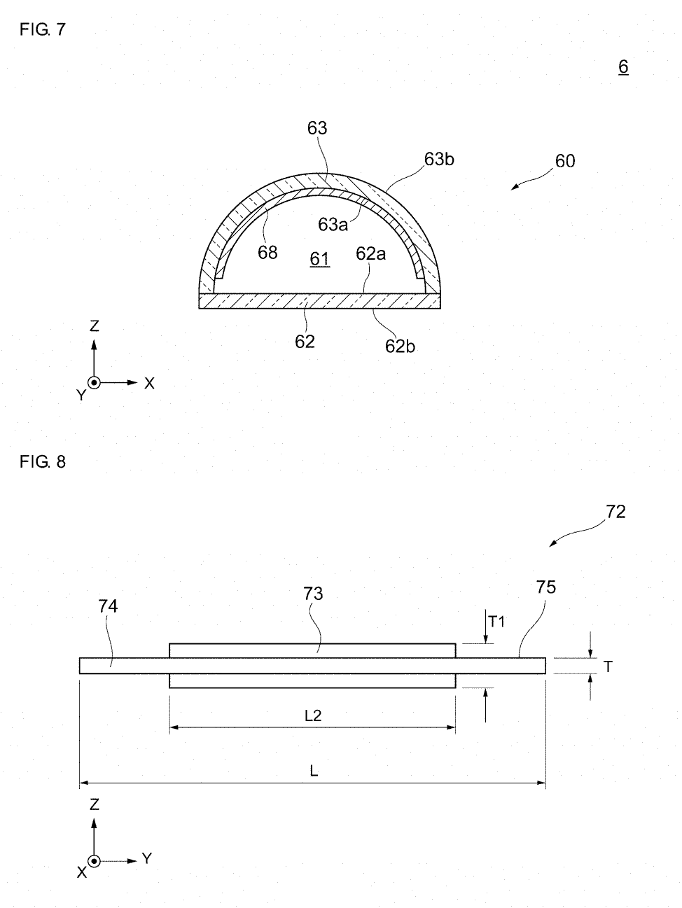

A light source window member according to a fourth embodiment of the present invention will be described with reference to FIG. 7. FIG. 7 is a cross-sectional view of the light source window member.

As shown in FIG. 7, the light source window member 6 of the present embodiment is different from the first embodiment in the shape of a tubular side wall member. The light source window member 6 has a tubular side wall member 60 and an irradiation window region provided at at least one surface of the tubular side wall member 60 (a plate-shaped member 62 in FIG. 7) and through which irradiation light from a light source is applied. The tubular side wall member 60 allows a light source, having a shape extending in a longitudinal direction, to be contained in an internal space 61 thereof.

The tubular side wall member 60 has a flat plate-shaped member 62 and a curved plate-shaped member 63. The plate-shaped member 62 has an inner surface 62a and an outer surface 62b that are flat surfaces, and the plate-shaped member 63 has an inner surface 63a and an outer surface 63b that are curved surfaces. In the plate-shaped member 63, the inner surface 63a facing the plate-shaped member 62 is a concave surface, and the outer surface 63b is a convex surface. The plate-shaped members 62 and 63 each have a longitudinal direction (Y-axis direction), and are jointed to each other in a lateral direction (X-axis direction), whereby the tubular side wall member 60 having a semi-cylindrical shape is formed.

In the example shown in FIG. 7, the plate-shaped members 62 and 63 are each made of artificial quartz. Alternatively, as described above, as a modification, the plate-shaped member 63 excluding the plate-shaped member 62 having the irradiation window region may be made of a material different from artificial quartz, such as quartz glass or metal.

In the example shown in FIG. 7, a reflective member 68 is provided on the inner surface 63a of the plate-shaped member 63. Accordingly, it is possible to also transmit the irradiation light reflected by the reflective member 68, through the plate-shaped member 62.

In the light source window member 6 according to the present embodiment, the tubular side wall member 60 may have a columnar shape formed by a combination of a flat plate and a curved plate. The shape of the tubular side wall member 60 in this case is not limited to the shape in FIG. 7, and, for example, a plate-shaped member composed of two or more flat plates may be used instead of the one plate-shaped member 62.

### Fifth Embodiment

A light source window member according to a fifth embodiment of the present invention will be described with reference to FIG. 8. FIG. 8 is a diagram showing a plate-shaped member of the light source window member.

As shown in FIG. 8, the light source window member of the present embodiment is different from the first embodiment in the configuration of a plate-shaped member having an irradiation window region. A tubular side wall member of the light source window member according to the present embodiment has a plate-shaped member 72 having an irradiation window region, and the plate-shaped member 72 is composed of an uneven plate.

Specifically, the plate-shaped member 72 has, in plan view from a thickness direction (Z-axis direction), a first portion 73 away from both end portions in a longitudinal direction, a second portion 74 adjacent to one side in the longitudinal direction of the first portion 73, and a third portion 75 adjacent to the other side in the longitudinal direction of the first portion 73. When the length in the longitudinal direction (Y-axis direction) of the plate-shaped member 72 is denoted by L and the length in the longitudinal direction (Y-axis direction) of the first portion 73 is denoted by L2, a relationship of L2<L is established. A thickness T1 of the first portion 73 and each thickness T of the second portion 74 and the third portion 75 have a relationship of T1>T. That is, the plate-shaped member 72 has a structure in which, in plan view from the thickness direction (Z-axis direction), a central portion that is the first portion 73 is thicker than peripheral portions that are the second portion 74 and the third portion 75. In other words, the plate-shaped member 72 has a mesa structure.

In the present embodiment as well, the plate-shaped member 72 is made of artificial quartz. It is possible to form the plate-shaped member 72 as such an uneven plate by etching a quartz plate made of artificial quartz.

Apart from the example shown in FIG. 8, each thickness T in the thickness direction (Z-axis direction) of the second portion 74 and the third portion 75 may be larger than the thickness T1 in the thickness direction (Z-axis direction) of the first portion 73. That is, the plate-shaped member 72 may have a structure in which, in plan view from the thickness direction (Z-axis direction), the central portion that is the first portion 73 is thinner than the peripheral portions that are the second portion 74 and the third portion 75. In other words, the plate-shaped member 72 may have a reverse mesa structure.

Moreover, the form in which the thickness of the plate-shaped member 72 varies in the longitudinal direction has been described in the example shown in FIG. 8, but, instead of or together with the form in which the thickness varies in the longitudinal direction, a form in which the thickness varies in the lateral direction may be applied.

Moreover, the form in which both the inner surface and the outer surface of the plate-shaped member 72 have an uneven shape has been described in the example shown in FIG. 8, but either surface may have an uneven shape, and the other surface may be a flat surface.

### Sixth Embodiment

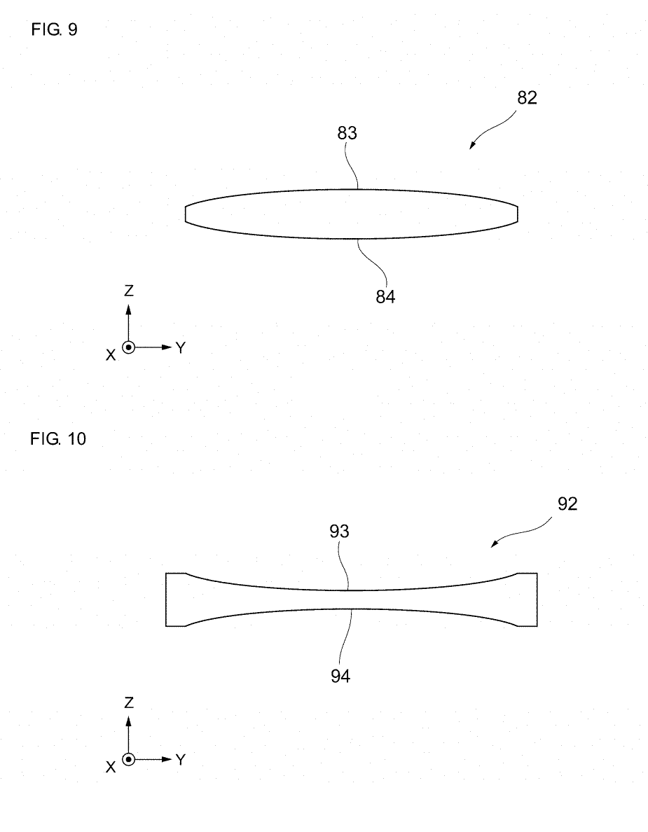

A light source window member according to a sixth embodiment of the present invention will be described with reference to FIG. 9. FIG. 9 is a diagram showing a plate-shaped member of the light source window member.

As shown in FIG. 9, the light source window member of the present embodiment is different from the first embodiment in the configuration of a plate-shaped member having an irradiation window region. A tubular side wall member of the light source window member according to the present embodiment has a plate-shaped member 82 having an irradiation window region, and the plate-shaped member 82 is composed of a curved plate. That is, at least one main surface of the plate-shaped member 82 is a substantially curved surface.

Specifically, the plate-shaped member 82 has a shape in which the thickness thereof in a thickness direction (Z-axis direction) continuously changes in a longitudinal direction. In this case, the plate-shaped member 82 has a convex inner surface 83 at the light source side, and a convex outer surface 84 at the side opposite to the light source, and is formed such that a central portion is thick and the thickness continuously decreases with decreasing distance to a peripheral portion in plan view from the thickness direction (Z-axis direction). In other words, the plate-shaped member 82 has a convex shape or a bevel shape.

The form in which the inner surface 83 and the outer surface 84 of the plate-shaped member 82 are curve surfaces has been described in the example shown in FIG. 9, but either surface may have a curved surface, and the other surface may be flat surface.

### Seventh Embodiment

A light source window member according to a seventh embodiment of the present invention will be described with reference to FIG. 10. FIG. 10 is a diagram showing a plate-shaped member of the light source window member.

As shown in FIG. 10, the light source window member of the present embodiment is different from the first embodiment in the configuration of a plate-shaped member having an irradiation window region. A tubular side wall member of the light source window member according to the present embodiment has a plate-shaped member 92 having an irradiation window region, and the plate-shaped member 92 is composed of a curved plate. That is, at least one main surface of the plate-shaped member 92 is a substantially curved surface.

Specifically, the plate-shaped member 92 has a shape in which the thickness thereof in a thickness direction (Z-axis direction) continuously changes in a longitudinal direction. In this case, the plate-shaped member 92 has a concave inner surface 93 at the light source side and a concave outer surface 94 at the side opposite to the light source, and is formed such that a central portion is thin and the thickness continuously increases with decreasing distance to a peripheral portion in plan view from the thickness direction (Z-axis direction).

The form in which the inner surface 93 and the outer surface 94 of the plate-shaped member 92 are curve surfaces has been described in the example shown in FIG. 10, but either surface may have a curved surface, and the other surface may be flat surface.

FIG. 9 and FIG. 10 may be applied in combination. That is, either surface of a plate-shaped member may be formed as a convex surface, and the other surface of the plate-shaped member may be formed as a concave surface.

As described above, the light source window member according to each embodiment of the present invention has the following configurations and advantageous effects achieved by one of the above configurations or a combination of some of the above configurations.

According to the embodiments described herein, since the irradiation window region is made of artificial quartz and is provided at at least one surface in the longitudinal direction of the tubular side wall member, it is possible to apply light in a wide range with good transmission. Therefore, it is possible to provide a light source window member that is able to improve light transmittance.

It should be noted that each embodiment described above is intended to facilitate understanding of the present invention and is not to be interpreted as limiting the present invention. The present invention can be modified or improved without deviating from the purpose, and the equivalents are included in this invention. In other words, appropriate design changes made to the embodiment by those skilled in the art are included in the scope of the invention as long as the features of the present invention are provided. For example, the elements and arrangement, materials, condition, shape, and size thereof included in the embodiment are not limited to those exemplified and can be modified appropriately. Moreover, the elements included in the embodiment may be combined as long as it is technically possible and are within the scope of the present invention as long as the combined elements include the features of the present invention.

### REFERENCE SIGNS LIST

1 light source window member
10 tubular side wall member
12, 14, 16 plate-shaped member
18a, 18b reflective member
22, 32 plate-shaped member
23, 33 irradiation window region

1. A light source window member for applying irradiated light from a light source, the light source window member comprising:
a tubular side wall member extending in a longitudinal direction and constructed to contain a light source therein; and
an irradiation window region provided at at least one surface of the tubular side wall member, wherein
the irradiation window region is made of artificial quartz.

2. The light source window member according to claim 1, wherein
the tubular side wall member has a plate-shaped member extending in the longitudinal direction, and
the irradiation window region is provided in the plate-shaped member.

3. The light source window member according to claim 2, wherein the plate-shaped member is composed of a flat plate, an uneven plate, or a curved plate.

4. The light source window member according to claim 3, wherein the plate-shaped member has a convex inner surface facing the light source, and a convex outer surface opposite to the light source.

5. The light source window member according to claim 3, wherein the plate-shaped member has a concave inner surface facing the light source, and a concave outer surface opposite to the light source.

6. The light source window member according to claim 2, wherein the irradiation window region extends to at least one end of the plate-shaped member in the longitudinal direction.

7. The light source window member according to claim 6, wherein, when a first width of the irradiation window in a lateral direction orthogonal to the longitudinal direction is denoted by W1 and a second width of the plate-shaped member in the lateral direction is denoted by W, W1<W.

8. The light source window member according to claim 6, wherein the irradiation window region extends to at least one end of the plate-shaped member in a lateral direction orthogonal to the longitudinal direction.

9. The light source window member according to claim 8, wherein, when a first length of the irradiation window region in the longitudinal direction is denoted by L1 and a second length of the plate-shaped member in the longitudinal direction is denoted by L, L1<L.

10. The light source window member according to claim 9, wherein L1<0.5×L.

11. The light source window member according to claim 9, wherein, when a width of the plate-shaped member in the lateral direction is denoted by W, L1>W.

12. The light source window member according to claim 2, wherein the irradiation window region extends to at least one end of the plate-shaped member in a lateral direction orthogonal to the longitudinal direction.

13. The light source window member according to claim 12, wherein, when a first length of the irradiation window region in the longitudinal direction is denoted by L1 and a second length of the plate-shaped member in the longitudinal direction is denoted by L, L1<L.

14. The light source window member according to claim 13, wherein L1<0.5×L.

15. The light source window member according to claim 1, wherein the tubular side wall member has a polygonal column shape.

16. The light source window member according to claim 1, wherein the tubular side wall member has a cylindrical shape.

17. The light source window member according to claim 1, wherein the tubular side wall member has a semi-cylindrical shape.

18. The light source window member according to claim 1, wherein the tubular side wall member is made of at least one or more of artificial quartz, quartz glass, and metal.

19. The light source window member according to claim 1, further comprising a reflective member provided on an inner surface of the tubular side wall member and configured to reflect the irradiated light from the light source.

20. The light source window member according to claim 1, wherein the light source is a lamp.
